(19) United States
(12) Patent Application Publication
(10) Pub. No.: US 2022/0354329 A1
(43) Pub. Date: Nov. 10, 2022

(54) FOREIGN OBJECT DEBRIS COLLECTION DEVICE

(71) Applicant: Wichita State University, Wichita, KS (US)

(72) Inventors: Brandon Thomas, Wichita, KS (US); Alexander VanPelt, Wichita, KS (US); Jennifer Weddle, Wichita, KS (US); Gregorio Balandran, Wichita, KS (US)

(21) Appl. No.: 17/734,017

(22) Filed: Apr. 30, 2022

Related U.S. Application Data
(60) Provisional application No. 63/184,832, filed on May 6, 2021.

(51) Int. Cl. A47L 11/24; B25J 9/16; B25J 11/00; A47L 11/40

(52) U.S. Cl. CPC A47L 11/24; B25J 9/1661; B25J 11/0085; A47L 11/4025; A47L 11/4038; A47L 11/4066; A47L 11/4069; A47L 11/4011; A47L 2201/00

(57) ABSTRACT

The present disclosure provides a Foreign Object Debris (FOD) Collection Device that comprises a carriage, a hitch, a holding chamber, a powered sweeper, and a funneling component. The carriage moves along a surface. The hitch couples the carriage to an Automated Mobile Robot (AMR) such that the automated robot drives movement of the carriage along the surface. The holding chamber is supported on the carriage and comprises an opening through which debris are passable into the holding chamber. The powered sweeper comprises a movable brush supported on the carriage and is operatively connected to a power supply of the Automated Mobile Robot. The funneling component is located between the movable brush and the holding chamber and is moved by the powered sweeper along surface S such that the debris swept by the movable brush are guided by the funneling component into the opening of the holding chamber.

### CROSS-REFERENCE TO RELATED APPLICATION

This application claims priority to U.S. Provisional Patent Application No. 63/184,832, filed May 6, 2021, which is hereby incorporated by reference in its entirety.

### FIELD

The present disclosure generally relates to foreign object debris sweepers, and more specifically, to a foreign object collection device attached to an automated mobile robot.

### BACKGROUND

Foreign object debris sweepers, generally, can be used for cleaning in office settings, household settings, warehouse settings, or industrial settings. Some foreign object debris sweepers used for cleaning can also be classified as Automated Mobile Robots (AMRs). Regarding warehouse setting use, the AMR needs to be able to collect foreign object debris that are made of denser materials such as nuts and bolts. Many warehouse settings currently use AMRs, which are specifically designed for transportation, such as a MiR100, and cleaning, such as a Makita DRC200Z. However, these AMRs are either designed for transporting or cleaning. The Makita DRC200Z, utilizes suction, which sometimes fails to pick up the denser nuts and bolts and statically sticks debris to brushes of the AMR. Therefore, there is a need for a foreign object debris sweeper that can be attached to AMRs, thereby providing greater cleaning efficiency and minimizes statically sticking debris.

### BRIEF SUMMARY

In one embodiment, the present disclosure provides a foreign object debris (FOD) collection device. The FOD collection device includes a carriage, a hitch, a holding chamber, a powered sweeper, and a funneling component. The carriage moves along a surface, and the hitch couples the carriage to an automated mobile robot (AMR) such that movement of the automated mobile robot drives movement of the carriage along the surface. The holding chamber is supported on the carriage and has an opening through which debris pass into the holding chamber. The powered sweeper has at least one movable brush that is supported on the carriage and moves relative to the carriage. The powered sweeper is operatively connected to a power supply of the automated mobile robot such that the powered sweeper draws power from the automated mobile robot and is able to move the at least one movable brush relative to the carriage. The powered sweeper moves the at least one movable brush relative to the carriage as the carriage is moved along the surface by the automated mobile robot so that the moveable brush sweeps debris on the surface toward the holding chamber. The funneling component is located between the movable brush and the holding chamber and guides the debris swept by the movable brush into the opening of the holding chamber.

In another aspect, a foreign object debris collection device comprises a carriage configured to move along a surface. A hitch is configured to couple the carriage to an automated mobile robot such that movement of the automated mobile robot drives movement of the carriage along the surface. A holding chamber is supported on the carriage and comprises an opening through which debris is passable into the holding chamber. A powered sweeper comprises a movable brush supported on the carriage for movement relative to the carriage. The powered sweeper is operatively connected to a power supply of the automated mobile robot to draw power from the automated mobile robot by which the powered sweeper moves the movable brush relative to the carriage. The powered sweeper is configured to move the brush relative to the carriage as the carriage is moved along the surface by the automated mobile robot so that the brush sweeps debris on the surface toward the holding chamber.

In another aspect, a foreign object debris collection device comprises a carriage configured to move along a surface. A hitch is configured to couple the carriage to an automated mobile robot such that movement of the automated mobile robot drives movement of the carriage along the surface. A holding chamber is supported on the carriage and comprises an opening through which debris is passable into the holding chamber. A powered sweeper comprises a movable brush supported on the carriage for movement relative to the carriage. The powered sweeper is operatively connected to a power supply of the automated mobile robot to draw power from the automated mobile robot by which the powered sweeper moves the movable brush relative to the carriage. The foreign object debris collection device is configured to operatively connect to the automated mobile robot such that the automated mobile robot can trailer the foreign object debris collection device for collecting foreign object debris into the holding chamber while the automated mobile robot performs another task in a facility.

In another aspect, a method of operating an automated mobile robot in a facility comprises performing a primary robot task in the facility using the automated mobile robot. While performing the primary robot task, foreign object debris is collected in a holding chamber of a foreign object debris collection device that is being trailered by the automated mobile robot.

Other aspects and features will be apparent hereinafter.

### BRIEF DESCRIPTION OF DRAWINGS

For a better understanding of the nature and objects of the disclosure, reference should be made to the following detailed description taken in conjunction with the accompanying drawings, in which:

FIG. 1 is an illustration of a foreign object debris (FOD) collection device.

FIG. 2 is an illustration of the FOD collection device attached to an automated mobile robot (AMR).

FIG. 3 is an illustration of the FOD collection device including a powered sweeper.

FIG. 4 is an illustration of the FOD collection device including a height HF.

FIG. 5 is an illustration of the FOD collection device including an opening.

FIG. 6 is an illustration of the FOD collection device including a dump mechanism.

FIG. 7 is a top plan view of the FOD collection device attached to the AMR.

FIG. 8 is a horizontal cross section taken through the plane of line 8-8 of FIG. 3.

FIG. 9 is a perspective of a funneling component of the FOD collection device.

FIG. 10 is a cross section taken through the plane of line 10-10 of FIG. 7.

FIG. 11 is an enlarged front perspective of the FOD collection device with a portion of a hitch thereof removed.

FIG. 12 is a perspective of a scoop of the FOD collection device.

Reference is made in the following detailed description of preferred embodiments to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

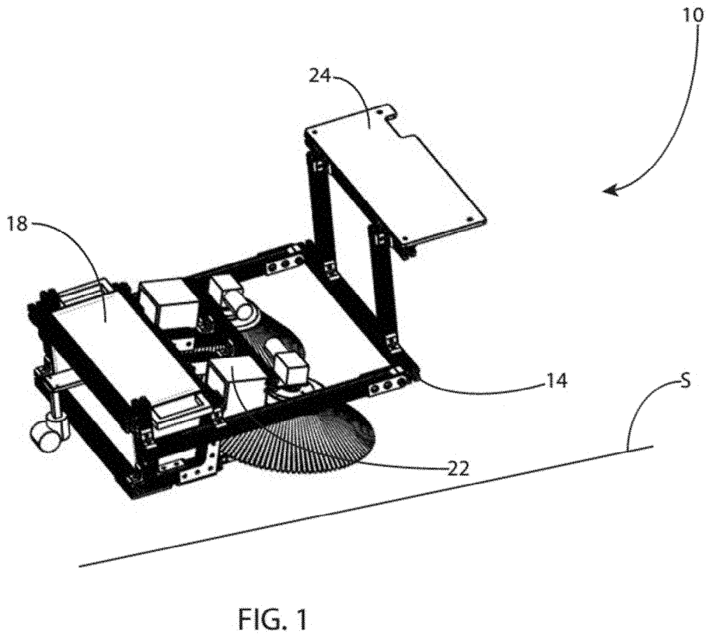

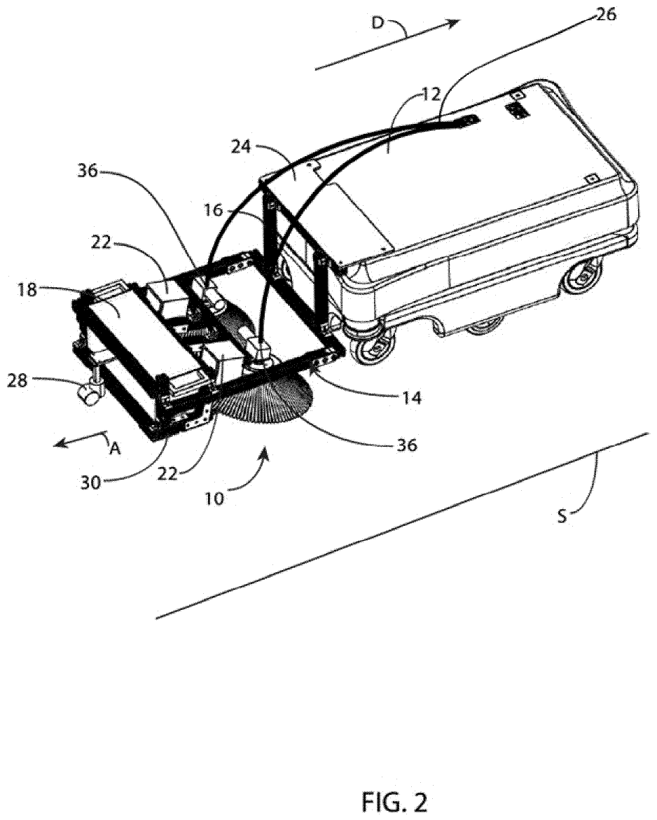

The present disclosure provides a foreign object debris (FOD) collection device 10, as illustrated in FIG. 1. The FOD collection device 10 of the present disclosure collects foreign object debris (e.g., nuts and bolts) off a surface S. Generally, the FOD collection device 10 of the present disclosure will be attached to an automated mobile robot (AMR) 12, as seen in FIG. 2. The AMR 12 can be, for example, a MiR100 AMR. The specifications of the FOD collection device 10 as provided in this disclosure can vary depending on the size and configuration of the AMR 12. In one or more embodiments the FOD collection device 10 can be coupled to an AMR to travel with the AMR as the AMR is performing its other functions in a facility. While the AMR performs its primary functions, the FOD collection device 10 can simultaneously perform a FOD collection function, thereby enhancing the capability of the AMR.

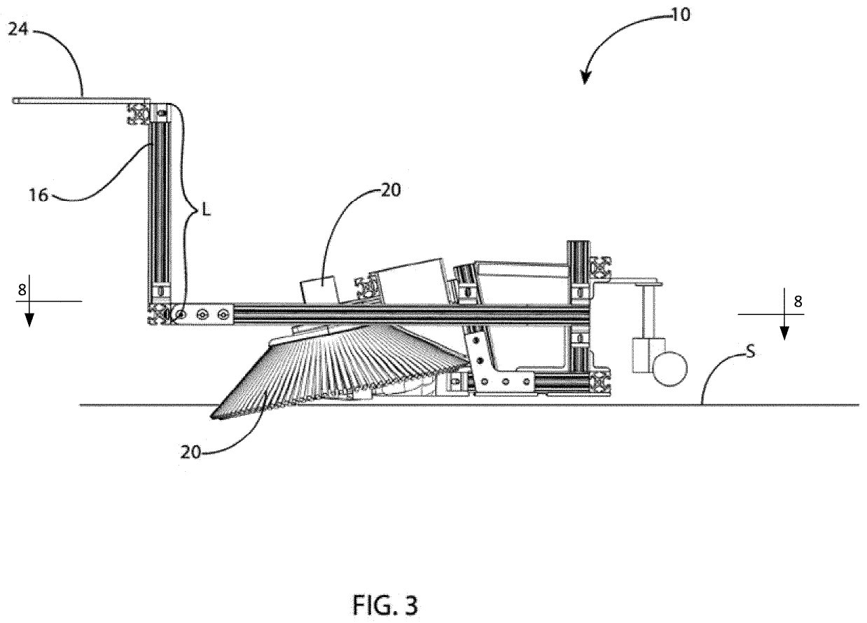

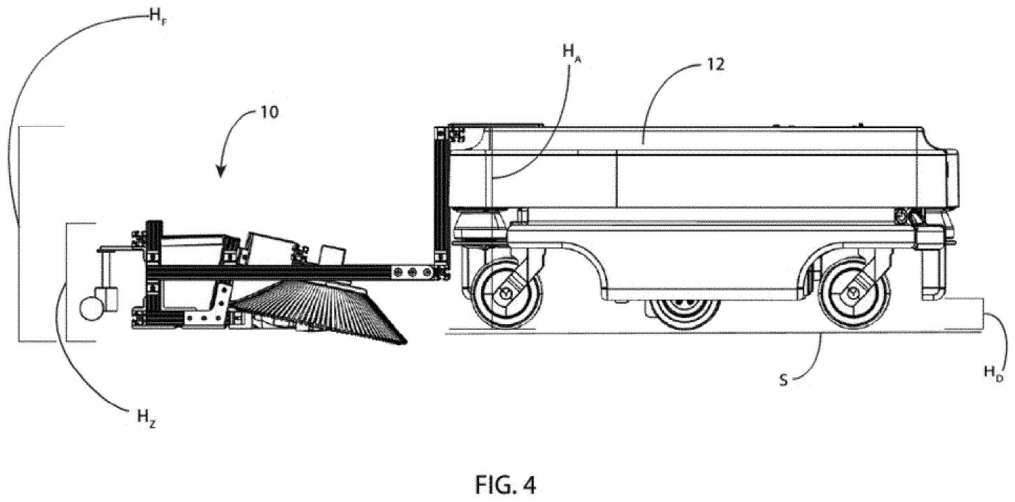

In accordance with the present disclosure, the FOD collection device 10 includes a carriage 14, a hitch 16, a holding chamber 18, a powered sweeper 20, and at least one funneling component 22. The carriage 14 is configured to move along the surface S. The hitch 16 couples the carriage 14 to the AMR so that, as the AMR moves, the carriage 14 travels with the AMR along the surface. In the illustrated embodiment, the hitch 16 comprises an L-shaped set of rails that support an attachment plate 24 with a pattern of holes corresponding with mounting holes formed in the top of the AMR. As seen in FIG. 3, the illustrated set of rails include vertical rails with a length L enabling the hitch 6 to operatively couple the collection device 10 to an AMR that has a height HA (FIG. 4). As best shown in FIG. 2, the AMR 12 has a power supply 26. Screws (broadly, removable fasteners) can pass through the holes in the plate 24 and thread into the corresponding holes formed in the top of the AMR to connect the FOD collection device to the AMR. As known to one skilled in the art, the hitch 16 may vary in size, shape, or dimension depending on the specifications and type of AMR

In an exemplary embodiment, the AMR 12 comprises an onboard power supply 26. The power supply 26 can power movement of the AMR 12, and by extension, movement of the carriage 14, in a direction D along the surface S.

In one embodiment, the carriage 14 includes at least one wheel 28 such that the wheel aids in movement of the carriage along the surface S. The wheel 28 allows the carriage 14 to roll along the surface S.

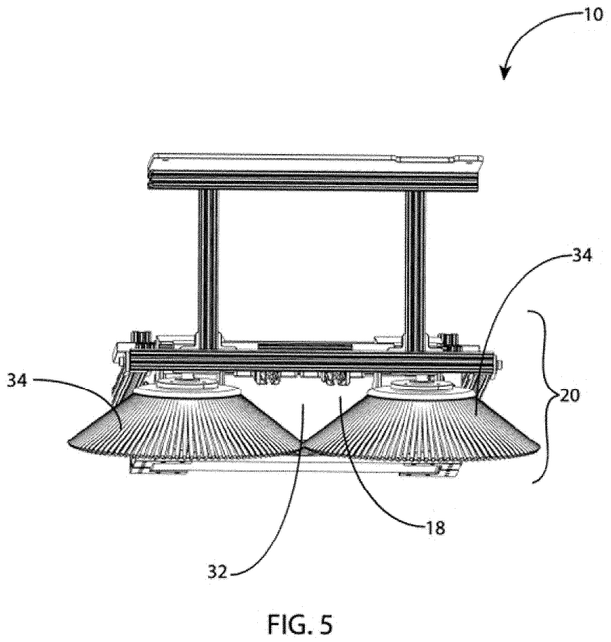

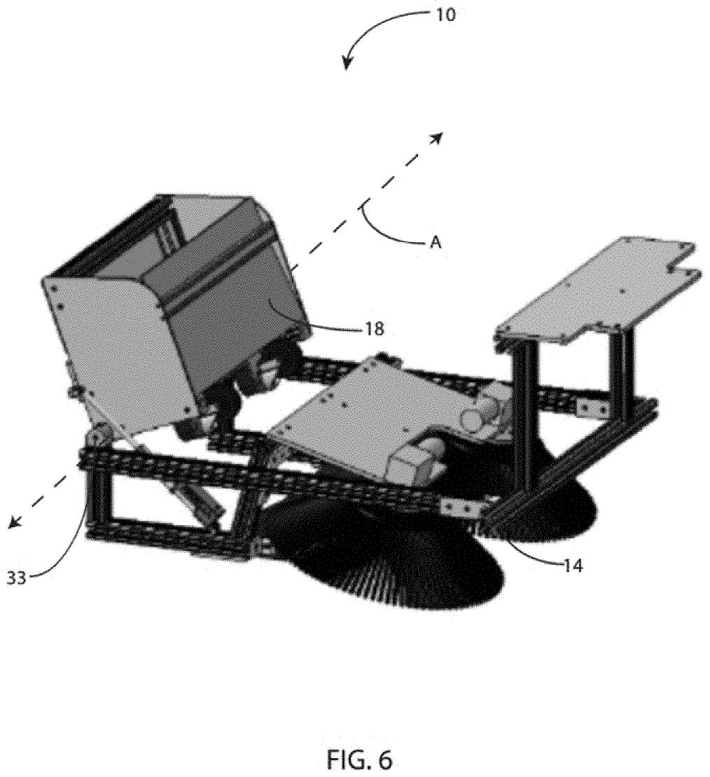

The holding chamber 18 is supported by the body 30 of the carriage 14. As shown in FIG. 5, the holding chamber 18 has an opening 32, such that debris (not shown) can pass into the holding chamber. In one embodiment, the FOD collection device 10 may include a debris removal mechanism such as a dump mechanism 33 for selectively removing debris from the holding chamber 18, as shown in FIG. 6. The dump mechanism 33 can rotate the holding chamber 18 about a dump pivot axis A with respect to the carriage 14. Specifically, the dump mechanism 33, shown in FIG. 6, can include a linear actuator that is connected to the power supply 26 of the AMR 12, as best shown in FIG. 2. The linear actuator of the dump mechanism 33 is selectively actuatable to rotate the holding chamber 18 about the dump pivot axis A. In the preferred embodiment, the dump mechanism 33 selectively removes debris from the holding chamber 18 into, for example, a structure external (not shown) to the FOD collection device 10, such as a waste bin located on the surface S or attached to the AMR 12. Alternatively, if the dump mechanism 33 is not included or automated, debris from the holding chamber 18 may be manually removed and placed into the external structure.

In the preferred embodiment, the powered sweeper 20 includes at least two movable brushes 34 connected to the power supply 26 of the AMR 12 such that the powered sweeper is continuously powered by the AMR. In one embodiment, the FOD collection device 10 can include a power converter (not shown) to convert electricity output from the AMR to a different voltage and/or current suitable for powering the powered sweeper 20. For instance, the power converter may convert the 48-volt output of the AMR 12 to a 12-volt input to the powered sweeper 20.

The powered sweeper 20 comprises motors 36 that rotate the movable brushes 34 relative to the carriage 14. It can be seen that each of the brushes 34 is generally circular (e.g., the brushes have bristles arranged in a frusto-conical brush arrangement) and configured to rotate about a respective axis of rotation at about the center of the circular brush. Each brush 34 is supported on a skew with respect to the underlying surface S such that a brush bottom defined by the tips of the bristles extends generally in a plane that slopes downwardly and longitudinally toward the AMR 12. The axis of rotation of each brush is correspondingly skewed at an angle orthogonal to this imaginary plane.

The motors 36 are configured to rotate the brushes 34 about the respective axes of rotation in counter-rotating directions such that, as the AMR 123 travels in the direction D, the leading portions of the brushes closest to the AMR 12 gather FOD laterally inward toward the space between the brushes and then the brushes carry and propel the FOD rearward toward the holding chamber 18. Thus, the rotating brushes 34 are configured to sweep foreign object debris on the surface toward and onward through the opening 32 of the holding chamber 18. The brushes 34 can be rotated at fixed or variable speeds, depending on the application. Suitably, the speed of the movable brushes 34 is set to maximize the proportion of swept debris that is swept into the holding chamber 18. In accordance with the current embodiment, the powered sweeper 20 moves the movable brushes 34 such that the FOD collection device 10 is able to collect, for example, nuts, bolts, washers, and metal shavings from surface S.

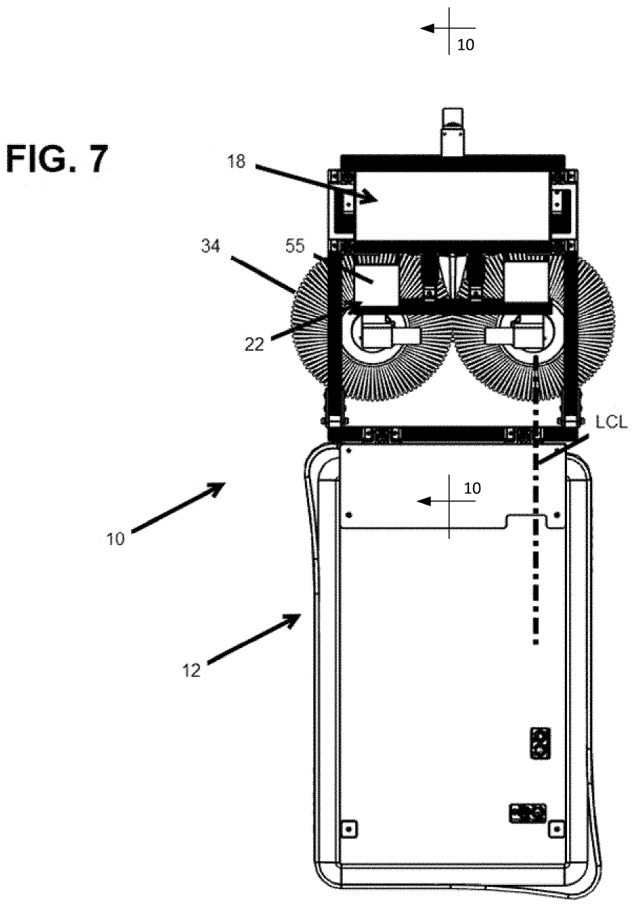

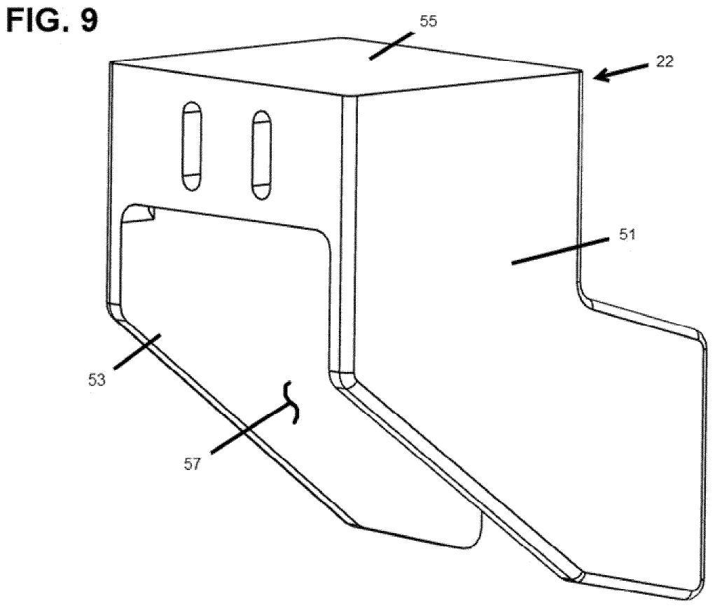

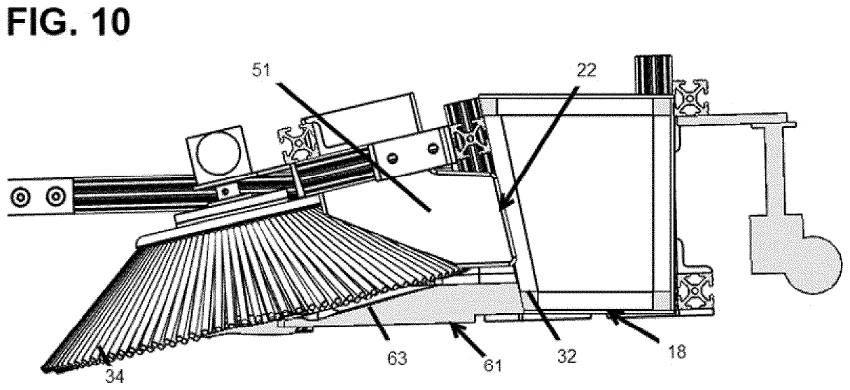

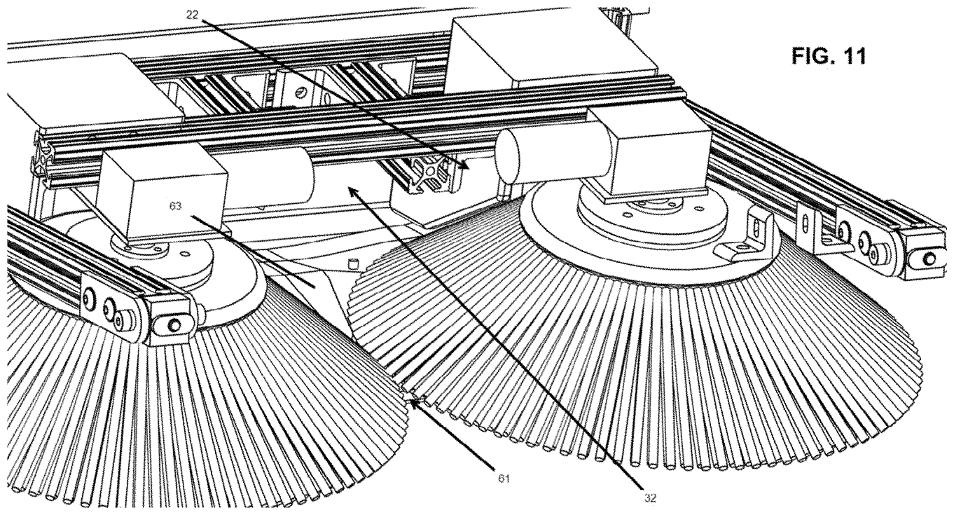

In the preferred embodiment, the present disclosure includes two funneling components 22 located generally above a trailing portion of the rotating brushes 34 and longitudinally between the brushes and the holding chamber 18. One funneling component 22 is located generally above each of the rotating brushes 34. As shown in FIGS. 7-11, each funneling component 22 comprises a leading (broadly, first) longitudinal end portion and a trailing (broadly, second) longitudinal end portion spaced apart along a longitudinal axis. Each of the illustrated funneling components 22 further comprises an inboard lateral wall 51 and an outboard lateral wall 53. An upper wall 55 connects the inboard lateral wall 51 to the outboard lateral wall 53. The inboard and outboard lateral walls define a through passage 57 therebetween that opens through the first and second longitudinal end portions of the funneling component. The through passage 57 is bounded on an upper end by the upper wall 55 and has an unbounded lower end. In other words, each funneling component 22 has an open bottom end between the lateral walls 51, 53.

Each of the lateral walls 51, 53 comprises a sloped lower edge margin that slopes at an angle that generally corresponds to a slope of an adjacent portion of the respective brush 34. Each funneling component 22 is mounted on the carriage 14 so that the lower edge margin of each lateral wall 51, 53 (i) is located immediately adjacent and (ii) extends parallel to the adjacent portion of the respective brush 34 so that there is substantially no gap between the lower edge margins of the funneling component and the brush.

Each funneling component overlaps (e.g., overlies) a trailing portion of the respective brush 34. In the illustrated embodiment, each funneling component intersects an imaginary lateral centerline LCL of the respective brush 36. The illustrated funneling components 22 are not laterally centered upon the respective lateral centerline. Instead, the funneling components 22 are offset laterally inward such that the inboard lateral wall 51 is laterally spaced apart from the centerline by a greater distance than the outboard lateral wall 53.

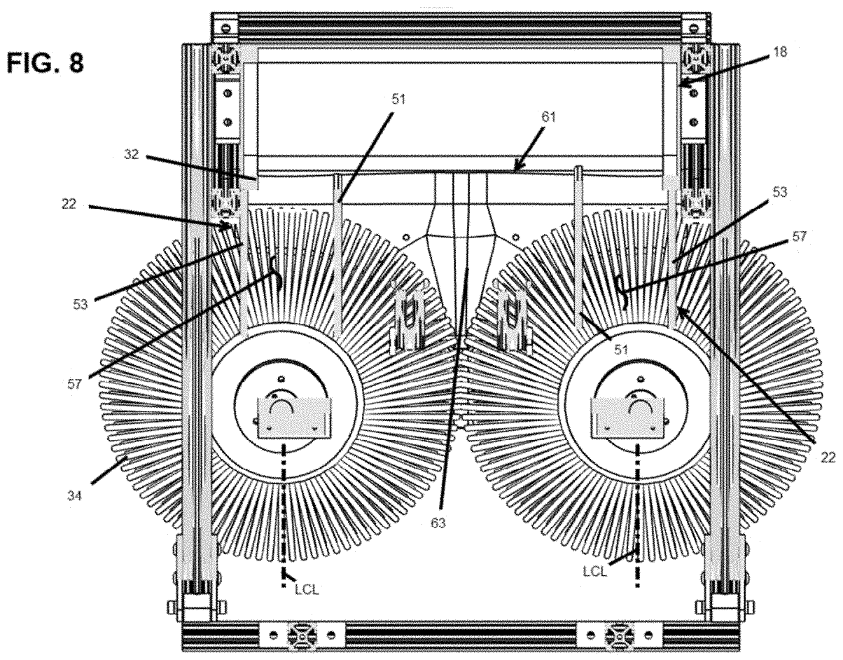

As can be seen in FIG. 8, the opening 32 to the holding chamber 18 has a width extending in a lateral direction from a left side edge to a right side edge. In the illustrated embodiment, the inboard wall 51 of each funneling component is spaced apart laterally inboard of the nearest side edge of the opening 32, and the outboard wall 53 is substantially aligned with the nearest side edge of the opening.

The inventors have recognized that foreign object debris such as paper, metal shavings, and wood may become statically charged during sweeping by the movable brushes 34 such that the foreign object debris adheres to the movable brushes. In the preferred embodiment, the funneling components 22 are formed from material that can neutralize the static charge between the foreign object debris and the movable brushes 34 thereby detaching the foreign object debris from the movable brushes when the foreign object debris encounter the funneling components 22.

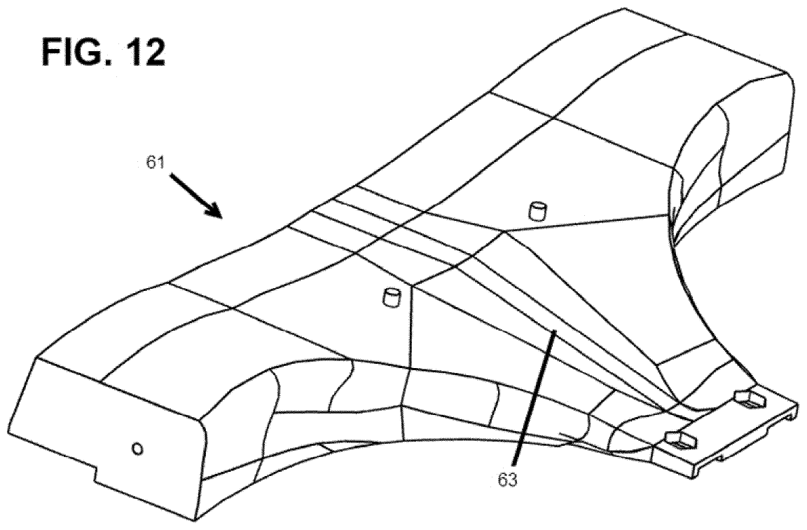

The illustrated FOD collection device 10 further comprises a scoop 61 extending forward from the front lower front portion of the holding chamber 18. The upper portion of the scoop 61 slopes downward toward the surface S as it extends forward. A trailing portion of each brush 34 is located above the scoop 61. The leading end of the scoop 61 is spaced apart in the trailing direction from the leading portions of the brushes 34. As shown in FIG. 12, the scoop is generally wedge shaped, with an upper surface that slopes downward in the forward direction. The trailing portions of the brushes 34 are located in a vertical space between the scoop 61 and the funneling components 22. The leading edge of the scoop 61 is contoured such that the scoop tapers laterally (e.g., the width of the scoop decreases) as it extends toward the forward end. The forward end of the scoop 61 is positioned as a wedge between the brushes 34, generally at the location where the brushes are configured to gather FOD between them during use. The upper portion of the scoop defines a central concavity 63 that extends longitudinally from the leading end toward the trailing end of the scoop.

During use, the AMR 12 trailers the FOD collection device 10 as the AMR performs one or more primary robot tasks. While the FOD collection device 10 is trailing the AMR 12, it draws power from the AMR power supply 26 to rotate the brushes 34 and thereby performs a secondary function of collecting FOD from the surface along which the AMR is traveling.

As the movable brushes 34 rotate relative to the carriage 14, the brushes sweep debris on the surface S toward the holding chamber 18. In particular, the two brushes 34 gather the debris from in front of the brushes inward into the area between them. The brushes 34 push the gathered debris rearward onto the leading end portion of the scoop 61. The brushes 34 carry the debris longitudinally along the concavity 63 toward the opening 32 of the holding chamber. As the debris approaches the opening 32, the points of contact between the debris and the brushes 34 begin moving laterally outward. This may cause some of the debris to begin to travel in a laterally outboard direction, but the inboard wall 51 of the funneling component 22 will deflect substantially all such debris toward and into the opening 32. Should any debris pass laterally outboard of the inboard wall 51 of a funneling component 22, the outboard wall 53 may provide a secondary deflector for deflecting the debris into the holding chamber 18 through the opening 32.

In one or more embodiments, the FOD collection device 10 is configured to travel with the AMR 12 without obstructing any portion of the field of view of the AMR scanner. In the illustrated embodiment, the carriage 14, sweeper 20, holding chamber 18, and funneling components 22 form a trailing subassembly of the FOD collection device having a maximum height Hz that is shorter than the scanning height of the AMR so that the ARM can scan its surrounding over the top of the trailing subassembly. In the illustrated embodiment, the hitch 16 of the FOD collection device 10 has a greater height HF, but the hitch is configured of low profile components (e.g., two widely spaced upright rails) that do not substantially interfere with AMR scanning. In the preferred embodiment, the scanner of the AMR 12 uses light, such as infrared light, to detect objects in its surrounding area. If no objects are in its surrounding area, as indicated by the infrared light, the AMR 12 is able to move along surface S unhindered. When an object is detected, the AMR 12 does not move along surface S towards the detected object. Configuring the FOD collection device 10 for use with the AMR without interfering with the scanning signal allows the FOD collection device to be used as a trailer that travels with the AMR as it carries out its regular duties.

The foregoing description has been presented for the purposes of illustration and description. It is not intended to be exhaustive or to limit the disclosure to the precise form disclosed. Many modifications and variations are possible in view of this disclosure. Indeed, while certain features of this disclosure have been shown, described and/or claimed, it is not intended to be limited to the details above, since it will be understood that various omissions, modifications, substitutions and changes in the apparatuses, forms, method, steps and system illustrated and, in its operation, can be made by those skilled in the art without departing in any way from the spirit of the present disclosure.

Furthermore, the foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed, many modifications and variations are possible in view of the above teachings. The embodiments were chosen and described in order to best explain the principles of the disclosure and its practical applications, to thereby enable others skilled in the art to best utilize the disclosed system and method, and various embodiments with various modifications as are suited to the particular use contemplated.

What is claimed is:

1. A foreign object debris collection device comprising:
a carriage configured to move along a surface;
a hitch configured to couple the carriage to an automated mobile robot such that movement of the automated mobile robot drives movement of the carriage along the surface;
a holding chamber supported on the carriage and comprising an opening through which debris is passable into the holding chamber;
a powered sweeper comprising a movable brush supported on the carriage for movement relative to the carriage, the powered sweeper being operatively connected to a power supply of the automated mobile robot to draw power from the automated mobile robot by which the powered sweeper moves the movable brush relative to the carriage, the powered sweeper being configured to move the brush relative to the carriage as the carriage is moved along the surface by the automated mobile robot so that the brush sweeps debris on the surface toward the holding chamber.

2. The foreign object debris collection device of claim 1, further comprising a funneling component between the brush and the holding chamber, the funneling component being configured to guide the debris swept by the brush into the opening of the holding chamber.

3. The foreign object debris collection device of claim 1, wherein the foreign object debris collection device is configured so that a scanner of the automated mobile robot can scan over a top portion of the foreign object debris collection device when the hitch couples the carriage to an automated mobile robot.

4. The foreign object debris collection device of claim 1, further comprising a debris removal mechanism for selectively removing debris from the holding chamber.

5. The foreign object debris collection system of claim 4, wherein the debris removal mechanism comprises a dump mechanism.

6. The foreign object debris collection system of claim 5, wherein the holding chamber is pivotably connected to the carriage for rotation about a dump pivot axis, the dump mechanism comprising a linear actuator between the carriage and the holding chamber selectively actuatable to rotate the holding chamber about the dump pivot axis with respect to the carriage.

7. A foreign object debris collection device comprising:
a carriage configured to move along a surface;
a hitch configured to couple the carriage to an automated mobile robot such that movement of the automated mobile robot drives movement of the carriage along the surface;
a holding chamber supported on the carriage and comprising an opening through which debris is passable into the holding chamber;
a powered sweeper comprising a movable brush supported on the carriage for movement relative to the carriage, the powered sweeper being operatively connected to a power supply of the automated mobile robot to draw power from the automated mobile robot by which the powered sweeper moves the movable brush relative to the carriage;
wherein the foreign object debris collection device is configured to operatively connect to the automated mobile robot such that the automated mobile robot can trailer the foreign object debris collection device for collecting foreign object debris into the holding chamber while the automated mobile robot performs another task in a facility.

8. A method of operating an automated mobile robot in a facility, the method comprising:
performing a primary robot task in the facility using the automated mobile robot; and
while performing the primary robot task, simultaneously collecting foreign object debris in a holding chamber of a foreign object debris collection device that is being trailered by the automated mobile robot.
